(19) United States
(12) Patent Application Publication
(10) Pub. No.: US 2011/0132998 A1
(43) Pub. Date: Jun. 9, 2011

(54) SPRAYHEAD AND DISPENSING DEVICE

(76) Inventor: Pepe Marzio, Milano (IT)

(21) Appl. No.: 12/995,651

(22) PCT Filed: Jun. 4, 2009
(86) PCT No.: PCT/EP09/03978

§ 371 Date: Feb. 18, 2011

(30) Foreign Application Priority Data
Jun. 4, 2008 (EP) 08010156.1
Jun. 30, 2008 (EP) 08011820.1

(51) Int. Cl. B05B 1/28

(52) U.S. Cl. 239/288; 239/302

(57) ABSTRACT

The present invention relates to an dispensing device with a sprayhead comprising a hemi-spherical cover pivotable around a horizontal axis.

The present invention relates to a sprayhead for dispensing a liquid according to the preamble of claim 1, and to a dispensing device for dispensing a liquid according to the preamble of claim 30.

In the present invention, the term “liquid” shall be understood preferably such that suspensions and other fluids are encompassed. The liquid may also contain gas phases and/or particles.

Preferably, the liquid is dispensed as a spray of fine droplets or a spray plume or as at least one beam. However, the liquid can also be dispensed in any other form, e.g. as foam or the like.

WO 99/33716 A1 discloses a sprayhead for a dispensing device for dispensing a liquid. The sprayhead comprises a rotatable cover for opening and closing a nozzle of the spray head. The nozzle is connected via a supply channel with a supply part. The supply part and the supply channel form part of a base supporting the cover. When the nozzle is open, the cover can be depressed in the direction of its rotation axis in order to cant the supply channel with the supply part. The supply part, in turn, depresses a movable valve element of a valve of an associated container, such as an aerosol can, to open the valve. Then, liquid of the container is dispensed via the valve element, the supply part, the supply channel and the nozzle into the environment.

The known sprayhead requires for convenient operation the use of two fingers to rotate the cover. Then, the finger position has to be changed in order to depress the cover for dispensing liquid. The operation of the known spray head is not intuitive.

US 2004/0222245 A1 discloses a spraying cap for a spray container. The spraying cap comprises an actuator element with spherical form, namely with a form like a flat bowl. This differs significantly from a hemispherical form. The actuator element is pivotable around a pivot axis located adjacent to one side of the actuator element. When actuating the sprayhead, a supply part is canted in order to open a valve of the spray container.

US 2006/0097014 A1 discloses a dispenser for delivering portions of pasty substances. The dispenser comprises an emptying nozzle with an associated squeeze head. The dispenser comprises a hood-like, non-hemispherical actuation element. The dispenser does not comprise a sprayhead.

WO 2006/066363 A1 discloses a dispensing device with a longitudinal cover member that is pivotable between a closed position and an open position.

U.S. Pat. No. 3,618,827 relates to a quarter-part-spherical cap for an aerosol container. The cap is mounted to rotate about a pivot axis to actuate a control valve of the container. The cap is not hemispherical. The valve is opened by canting a supply part.

Object of the present invention is to provide an improved sprayhead and dispensing device for dispensing a liquid, which allow in particular easy operation, preferably with only one finger and/or without change of finger position.

The object is achieved by a sprayhead according to claim 1 or by a dispensing device according to claim 30. Preferred embodiments are subject of the sub-claims.

According to the present invention, the cover is at least essentially hemi-spherical. This facilitates operation, in particular allows one-finger operation and/or operation without change of finger position.

In contrast to the prior art, the present invention provides a cover which is at least essentially hemispherical. This allows complete coverage of the free end of the sprayhead in the closed position.

The hemispherical design of the cover results in further advantages. The sprayhead may comprise a relatively smooth outer surface in the closed and open position of the cover. Intuitive actuation can be supported. A separate cap or the like can be avoided. The production and assembly of the sprayhead can be facilitated.

According to a further aspect of the present invention, the cover of the sprayhead can be pivoted around a pivot axis between a closed position covering the nozzle and/or blocking actuation of the sprayhead, and an open position for uncovering the nozzle and/or unblocking actuation of the sprayhead, wherein the pivot axis extends at least essentially horizontally and/or transversally to an actuation direction for opening or initiating supply of liquid. This facilitates operation, in particular allows one-finger operation and/or operation without change of finger position.

Further aspects, features, advantages and characteristics of the present invention will be apparent from the following description of preferred embodiments with reference to the drawings. It shows:

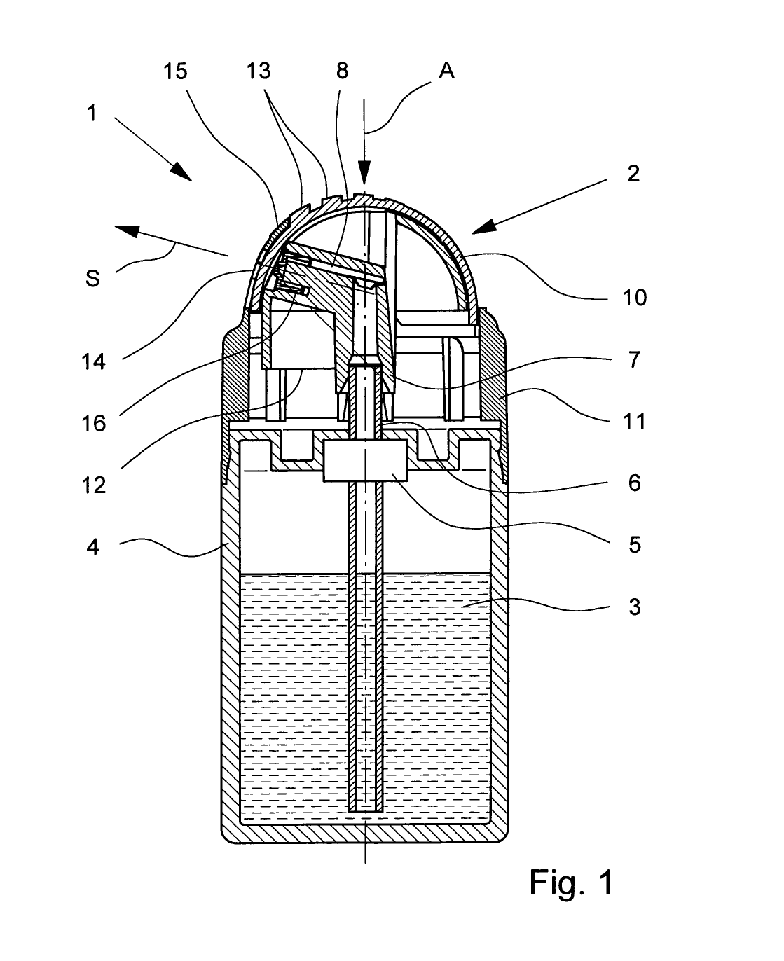

FIG. 1 a partial schematic section of a dispensing device with a sprayhead according to a first embodiment of the present invention in the closed position;

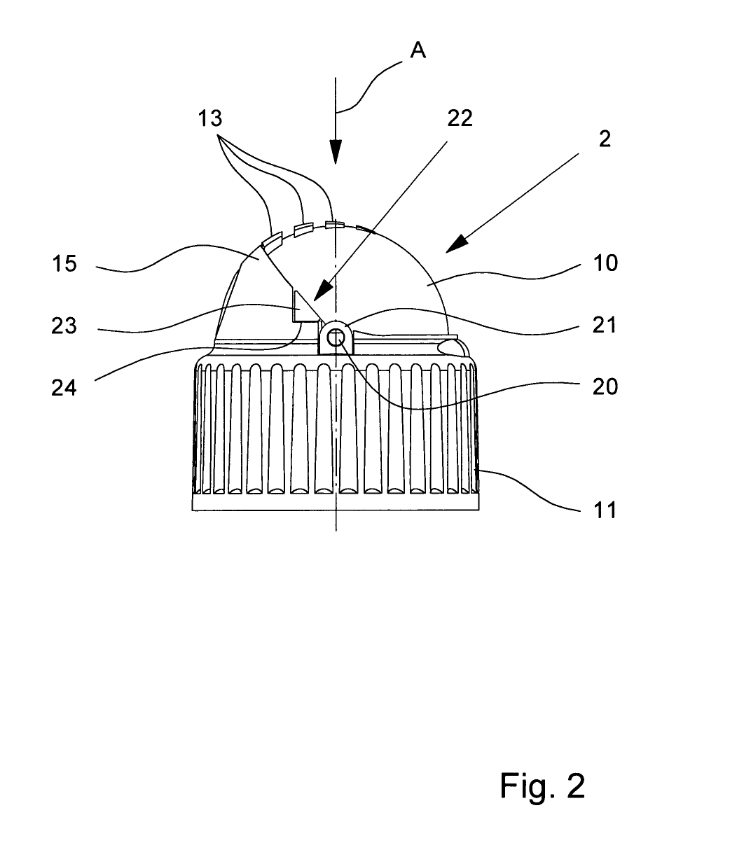

FIG. 2 a side view of the sprayhead in the closed position;

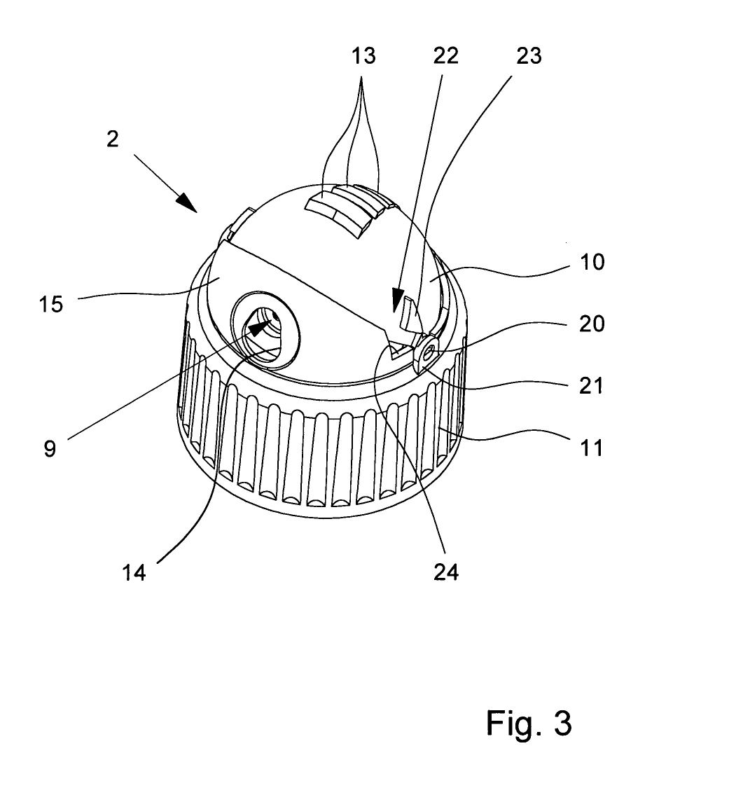

FIG. 3 a perspective view of the sprayhead according to FIG. 1, but in the open position;

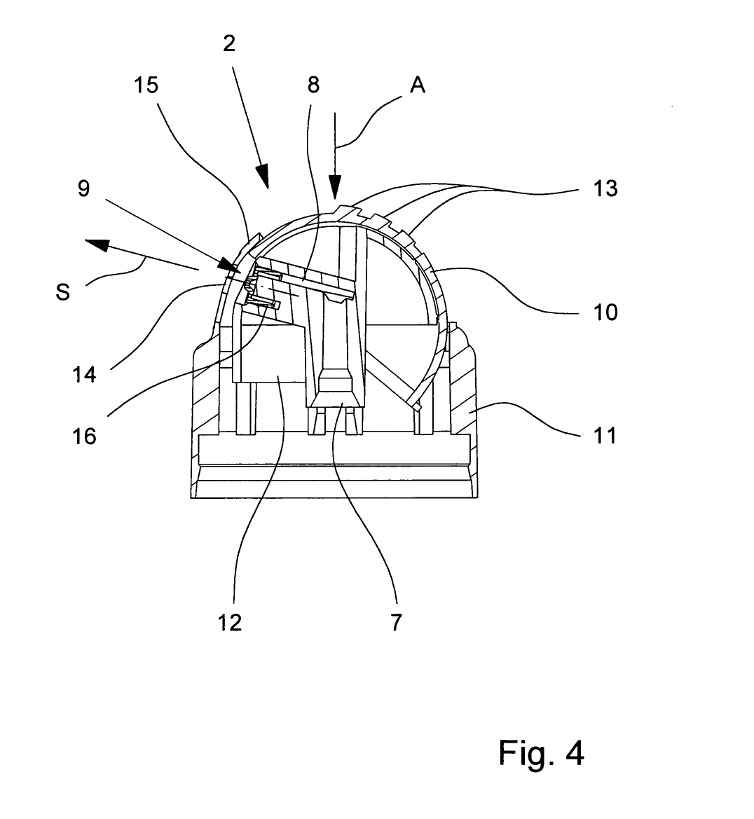

FIG. 4 a schematic section of the sprayhead in the open position;

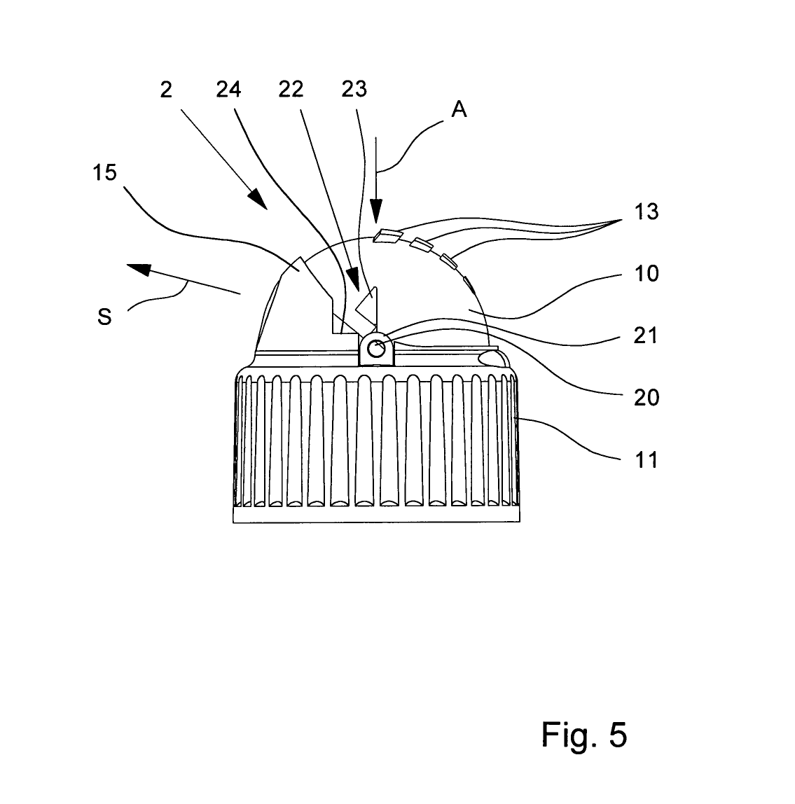

FIG. 5 a side view of the sprayhead in the open position;

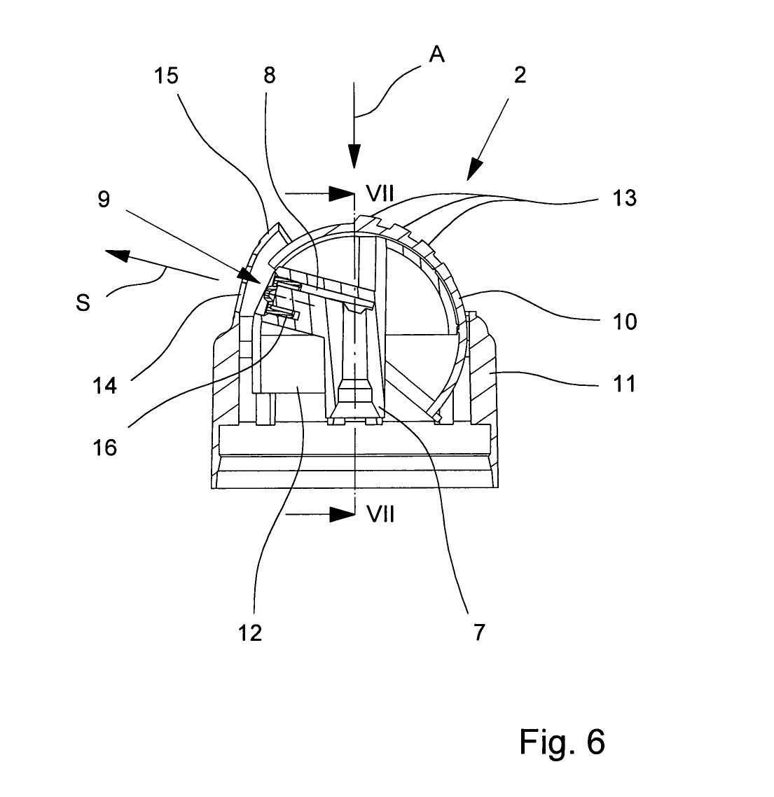

FIG. 6 a schematic section of the sprayhead in the open position with depressed cover;

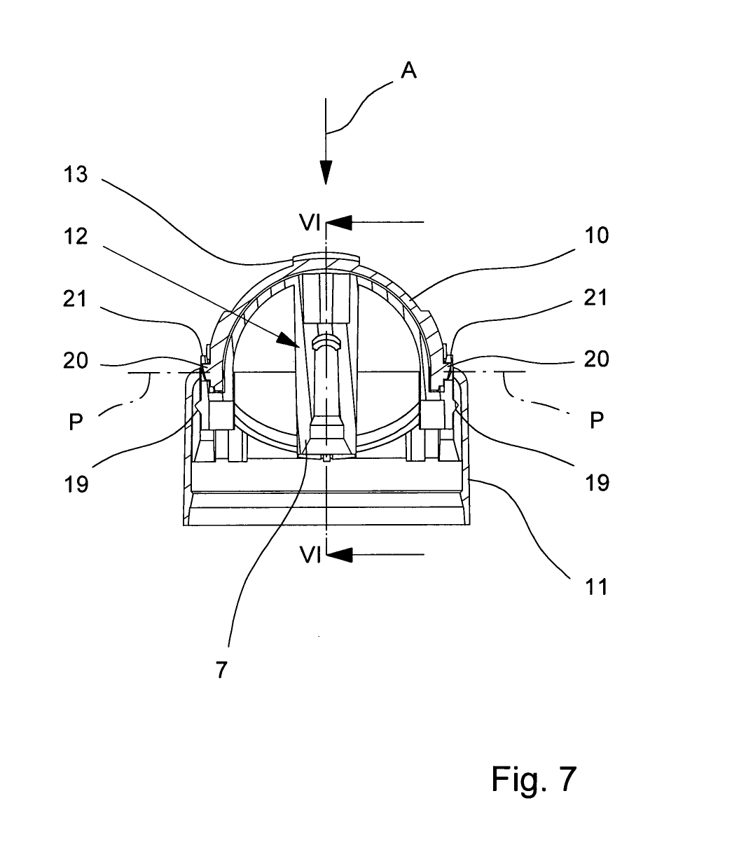

FIG. 7 another schematic section of the sprayhead in the open position with depressed cover;

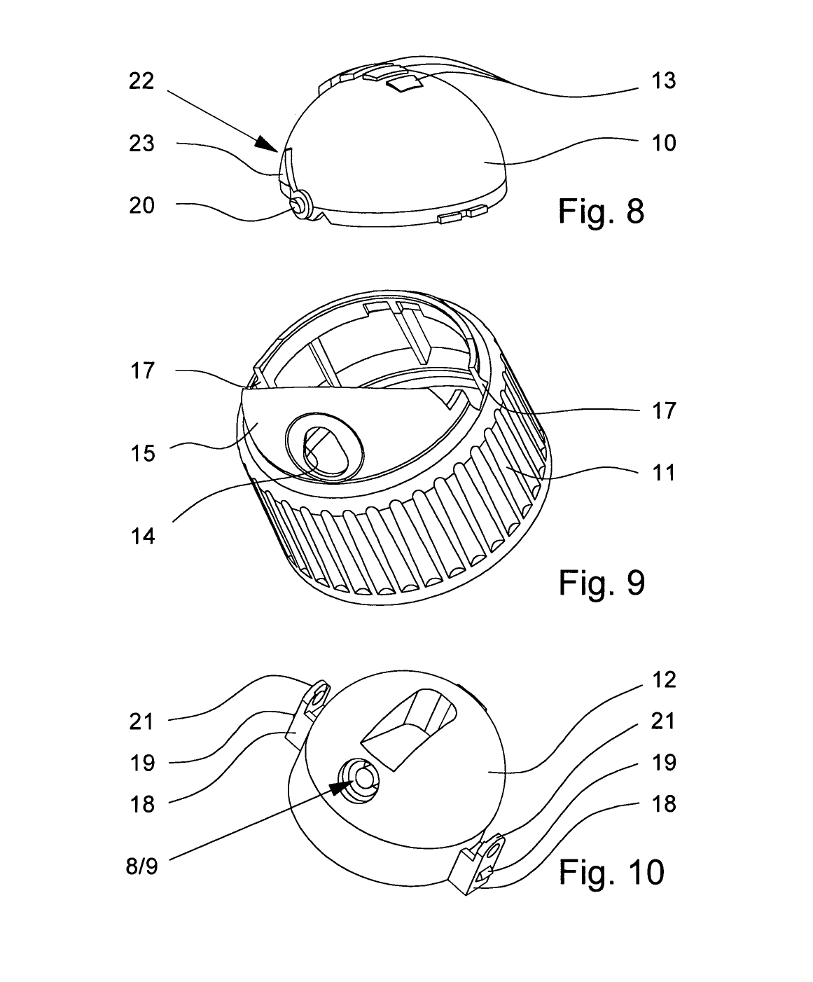

FIG. 8 a perspective view of the cover;

FIG. 9 a perspective view of a base of the sprayhead;

FIG. 10 a perspective view of a supply member of the sprayhead;

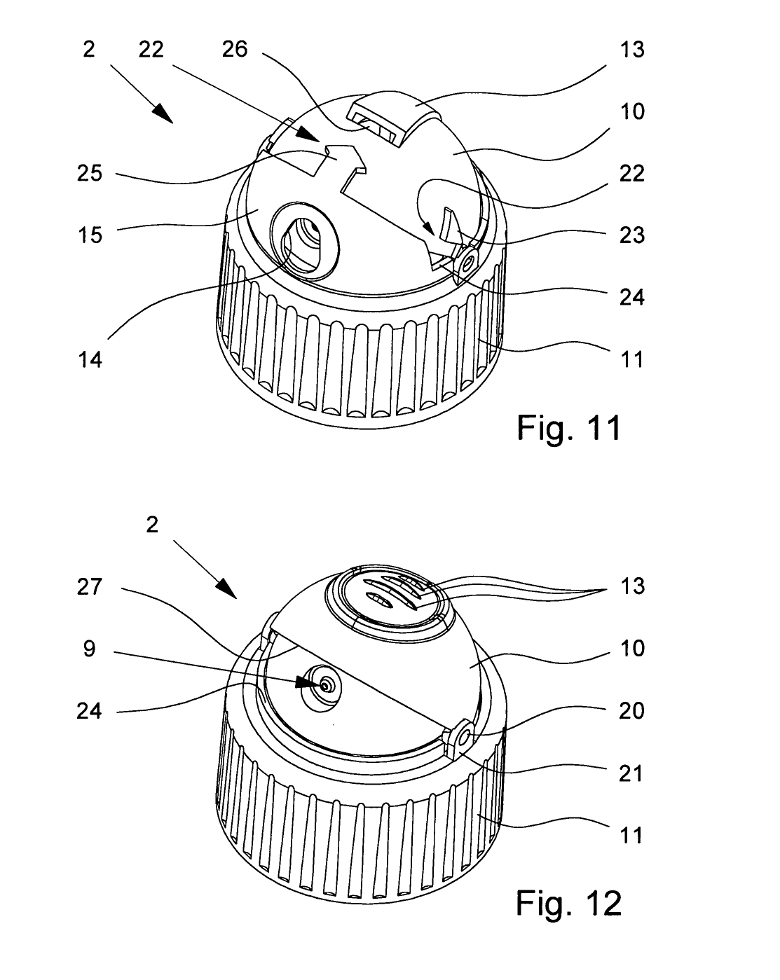

FIG. 11 a perspective view of the sprayhead according to a second embodiment of the present invention in the open position;

FIG. 12 a perspective view of a sprayhead according to a third embodiment of the present invention in the open position;

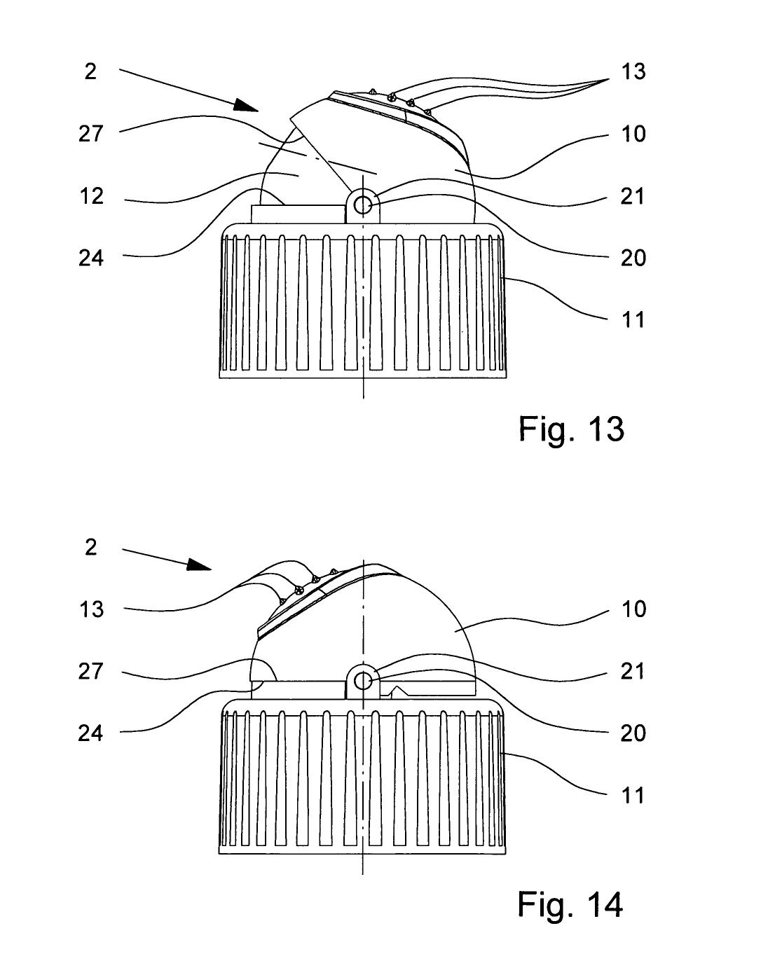

FIG. 13 a side view of the sprayhead in the open position; and

FIG. 14 a side view of the sprayhead in the closed position.

In the figures, the same reference signs are used for the same or similar parts and components wherein corresponding or similar characteristics, features and/or advantages can be achieved even if a repeated description is omitted.

FIG. 1 shows in a schematic section a dispensing device 1 with a sprayhead 2 according to a first embodiment of the present invention for dispensing a liquid 3 in the sense mentioned above.

The dispensing device 1 comprises a container 4, e.g. a metallic can, for the liquid 3, and preferably an outlet device, in particular a valve 5, for supplying liquid 3 to the sprayhead 2.

The liquid 3 is preferably under pressure in the container 4 or can be set under pressure. In particular, the container 4 and/or the liquid 3 contain a suitable propellant, a compressed gas, carbon dioxide and/or any other suitable pressure means or a pump.

The sprayhead 2 is mounted on the container 4 or valve 5. In the shown embodiment, the sprayhead 5 is preferably clamped onto the container 4, in particular on a rim of the container 4. However, the sprayhead 2 can be connected with or mounted on the container 4 in any other suitable manner. Alternatively, the sprayhead 2 could be used with a dispenser, pump or the like.

In the present embodiment, the valve 5 comprises a valve element 6 forming an outlet for the liquid 2. The valve element 6 is preferably tube-like. The valve element 6 is preferably moveable, in particular depressible in its lengthwise direction, in particular against a spring force, to open the valve 5. However, other constructional solutions are possible.

The sprayhead 2 comprises preferably a supply part 7 through which the liquid 3 can be supplied to the sprayhead 2. In particular, the supply part 7 is fluidically connectable or connected to the container 4, valve 5 or valve element 6. For example, the supply part 7 forms a connection sleeve into which the valve element 6 can be inserted or vice versa.

The sprayhead 2 comprises preferably a supply channel 8 and/or a nozzle 9. In particular, the nozzle 9 is fluidically connected with the supply part 7 via the supply channel 8. For dispensing, liquid 3 is supplied to the sprayhead 2 via the supply part 7. Then, the liquid 3 is guided via the supply channel 8 to the nozzle 9 where the liquid 3 is dispensed, in particular atomized or outputted as a spray plume, a spray plume or the like. Further, the liquid 3 could also be dispensed as foam or in any other suitable manner.

In the present embodiment, the sprayhead 2 preferably comprises a cover 10 (also shown in FIG. 8), a base 11 (also shown in FIG. 9) and/or a supply member 12 (also shown in FIG. 10).

The cover 10 is associated to the nozzle 9 and pivotable around a pivot axis P (compare FIG. 7) between a closed position and an open position and vice versa. In the closed position, the cover 10 covers the nozzle 9 and/or blocks actuation of the sprayhead 2. In the open position, the cover 10 uncovers the nozzle 9 and/or unblocks actuation of the sprayhead 2.

Actuation of the sprayhead 2 (dispensing of liquid 3) is achieved by moving the supply part 7 in an actuation direction A to depress the valve element 6 and, thus, open the valve 5. The supply part 7 is moved in the actuation direction A when the cover 10 is depressed in this direction. This is preferably only possible when the cover 10 is not closed, in particular is in its open position.

FIG. 2 shows a side view of the sprayhead 2 with closed cover 10.

FIG. 3 shows a perspective view of the sprayhead 2 with open cover 10.

FIG. 4 shows a schematic section of the sprayhead 2 with open cover 10. In the open position, the sprayhead 2 can be actuated so that liquid 3 can be dispensed. Preferably, the liquid 3 is dispensed in a main direction indicated in FIG. 4 by spray direction S. The spray direction S preferably extends at least essentially horizontally or towards a side of the dispensing device 1 with respect to the most common orientation of the dispensing device 1 shown in FIG. 1 with the sprayhead 2 at the top and the container 4 at the bottom. However, any other orientation and/or any other spray direction S is/are possible as well.

As already mentioned, the liquid 3 may be ejected or dispensed as a more or less focused beam, multiple beams or as a spray plume which may be focused more or less. Alternatively, the liquid may be dispensed as foam or in any other suitable manner. In any case, the spray direction S shall be understood as the main outlet direction or main direction of ejection of the sprayhead 2 or nozzle 9.

FIG. 5 shows a side view of the sprayhead 2 with open cover 10.

FIG. 6 shows a schematic section of the sprayhead 2 similar to FIG. 1, but without container 4. The sprayhead 2 is actuated, i.e. the cover 10 is open and depressed. FIG. 7 shows the same situation in perpendicular section.

Preferably, the cover 10 is moved or depressed—in particular manually by means of a finger (not shown) pressing on the cover 10, in particular on a grip or actuation portion 13 of the cover 10—so that the supply part 7 is moved in the actuation direction A for opening or initiating supply of liquid 3, i.e. by opening the associated valve 5 or depressing or moving the valve element 6.

Preferably, the cover 10 is movable jointly with the supply part 7 in the actuation direction A.

Preferably, the cover 10 and/or supplying part 7 are/is movable at least essentially only translationally, e.g. only linear, in the actuation direction A.

FIG. 7 shows the pivot axis P of the cover 10. Preferably, the pivot axis P extends essentially horizontally and/or transversally, in particular perpendicularly, to the actuation direction A. Preferably, the pivot axis P extends transversally, in particular perpendicularly, to the outlet direction of the valve 5 or its valve element 6.

The cover 10 is preferably at least essentially hemispherical as shown in FIG. 8. This facilitates operation with one finger and/or intuitive operation. The actuation portion 13 is formed preferably in a top region of the sprayhead 2 and/or at or near the top of the hemisphere.

Preferably, the grip actuation portion 13 is formed integrally with or by the cover 10.

Preferably, the actuation portion 13 is formed by or comprises at least one protrusion or the like facilitating actuation of the sprayhead 2/cover 10. Alternatively or additionally, the actuation portion 13 may form a symbol or arrow in order to (further) facilitate operation of the sprayhead 2 for a user (not shown).

In particular, the cover 10 forms a separate part. Preferably, the cover 10 is at least essentially rigid.

The base 11 shown in FIG. 9 forms preferably a rigid and/or separate part. The base 11 connects the sprayhead 2 with the container 4. For example, the base 11 comprises a respective ring part or other connection parts clamping on a rim of the container 4 or the like. However, other constructional solutions are possible as well.

Preferably, the sprayhead 2 comprises an opening 14, wherein the liquid 3 can be dispensed through the opening 14 when the cover 10 is in its open position (uncovered nozzle 9) and the sprayhead 2 is actuated. The opening 14 may be formed by or in the cover 10. In the present embodiment, however, the opening 14 is preferably formed by or in the base 11. In particular, the base 11 forms or comprises a covering part 15 with the opening 14 as shown in FIG. 9.

It has to be noted that the covering part 15 is optional. The covering part 15 is preferably formed integrally with or by the base 11.

In the present embodiment, the covering part 15 forms essentially a section of the surface of a ball and/or is adapted to the surface of the cover 10. In particular, the covering part 15 is designed to (partially) overlap the cover 10 at least when the cover 10 is in its closed position. However, other constructional solutions are possible.

When the opening 14 is formed in the base 11, it is possible that the cover 10 opens and closes (covers or uncovers or unblocks and blocks) the nozzle 9 by a rim part or edge portion of the cover 10. Depending on the position of the cover 10, the rim part or edge portion overlaps (covers) the nozzle 9 or not.

The supply member 12 is shown in a perspective view in FIG. 10 and in sectional views in FIGS. 1, 4, 6 and 7. Preferably, the supply member 12 is a rigid and/or separate part of the sprayhead 2.

The supply member 12 preferably forms or holds the supply part 7, the supply channel 8 and/or the nozzle 9. In the present embodiment, the supply part 7 and/or the supply channel 8 are/is formed integrally with or by the supply member 12.

In particular, the supply part 7 extends at least essentially in the actuation direction A, i.e. in the outlet direction of the container 4, valve 5 and/or valve element 6. The supply channel 8 preferably extends into the spray direction S and/or extends angled or transversally to the main direction of the supply part 7 and/or to the actuation direction A.

The nozzle 9 may be formed directly by the supply member 12, the supply channel 8 and/or a nozzle insert 16 as schematically shown in the sections according to FIGS. 1 and 4.

Preferably, the nozzle 9 forms a swirl chamber to achieve a defined discharge characteristic of the liquid 3. However, other constructional solutions are possible.

Preferably, the nozzle 9 is moveable together with the supply part 7 and/or the cover 10 in the actuation direction A when the sprayhead 2 or cover 10 is actuated, in the present embodiment depressed downwardly. FIGS. 6 and 7 show the actuated or depressed position. In this position, the valve element 6 (here not shown) is depressed as well so that the valve 5 is opened and the liquid 3 can be dispensed.

It has to be noted that the valve 5 can be any suitable valve, if desired also a metering or dosing valve.

Alternatively, the sprayhead 2, cover 10 and/or supply part 7 can actuate any other liquid supply, i.e. a dispenser, pump or the like, in particular by the movement in the actuation direction A or any other direction.

In the present embodiment, the movement in actuation direction A is preferably translational, i.e. linear. However, the movement may have only a translational component in the actuation direction A or may be different. For example, the actuation movement could also be curved and/or inclined to the preferred actuation direction A.

Preferably, the supply member 12 is held or supported by the base 11 in particular such that the supply member 12 is (preferably only) moveable in the actuation direction A forth and back.

In particular, the base 11 forms a guide for the supply member 12. Preferably, the guide comprises at least one groove 17—here two grooves 17 on opposite sides in the base 11—for engagement of the supply member 12. In particular, the supply member 12 comprises at least one protrusion 18, such as a ridge, rail or the like, engaging into the respective groove 17. Thus, the desired, in particular linear guide of the supply member 12/supply part 7 can be achieved. However, other constructional solutions are possible as well.

In order to restrict the moveability of the supply member 12 relative to the base 11 and/or to achieve a desired holding force of the supply member 12 in the depressed and/or not depressed position, a respective means for inter engagement may be provided. This means may comprise e.g. noses 19, in particular formed at the supply member 12, its protrusions 18, for engaging into respective recesses, in particular in the base 11 or grooves 17, as shown schematically in FIGS. 7 and 10. However, other constructional solutions are possible as well.

Preferably, the cover 10 is supported by or connected with the supply member 12. In particular, the cover 10 is pivotable connected with and/or held by the supply member 12.

Preferably, the pivotal connection of the cover 10 with the sprayhead 2, here with the supply member 12, is designed such that the cover 10 is pivotally held on two opposing sides and/or that the pivotal connection can be achieved by clicking the cover 10 and the supply member 12 together.

In the present embodiment, the cover 10 comprises at least one bearing bolt 20, in particular two bearing bolts 20 on opposite sides, preferably formed integrally with the cover 10. Preferably, the bearing bolts 20 protrude in opposite directions.

The supply member 12 comprises at least one bearing part or arm 21, in particular two bearing arms 21 on opposite sides, respectively comprising a bearing hole for receipt of the associated bearing bolt 20. In the present embodiment, the arms 21 are held by the protrusions 18.

Preferably, the bearing arms 21 are flexible and/or the bearing bolts 20 comprise inclined ends to allow the desired click connection (engagement of the bolts 20 into the bearing holes) for forming the pivotal joint of the cover 10 with the supply member 12. However, other constructional solutions are possible as well.

When the sprayhead 2 is mounted, the nozzle insert 16 is inserted into the supply member 12 or supply channel 8 to complete the nozzle 9 in a first step, if necessary. Then, the cover 10 is pivotable connected with or to the supply member 12. Afterwards, the assembly of cover 10 and the supply member 12 is inserted into the base 11, in the present embodiment preferably from the bottom of base 11. Then, the sprayhead 2 can be mounted on the container 4 whereby the supply part 7 is connected in a suitable manner to the container 4, valve 5 or in particular valve element 6.

Preferably, the connection between the supply part 7 and the valve element 6 is relatively loose or comprises a certain play in the non-operated state of the sprayhead 2 in order to avoid any undesired opening of the valve 5 and discharge of liquid 3. In particular, only when the sprayhead 2 is actuated, i.e. the cover 10 is depressed after it has been opened; the supply part 7 connects the valve element 6 fluidically tightly and pushes or depresses the valve element 6 to open the valve 5. However, other constructional solutions are possible as well.

Preferably, the supply member 12 is covered completely by the base 11 and/or cover 10, in particular when the cover 10 is in its closed position. Then, actuation of the supply member 12 and the supply part 7 in the actuation direction A is only possible by respective actuation of the cover 10. If the cover 10 is locked against actuation (depression), this prevents depression of the supply member 12 and/or supply part 7 so that discharge of liquid 3 can be prohibited.

Preferably, the cover 10 is connected—in particular in a form-fit manner—with the supply member 12 such that the supply member 12 can only be depressed or moved in the actuation direction A jointly with the cover 10, but not independently thereof. This prevents any undesired movement in the actuation direction A, e.g. when the dispensing device 1 falls on the floor or the like, so that any undesired dispensing of liquid 3 could be prevented.

The sprayhead 2 comprises preferably a locking device 22 for locking the cover 10 and/or supply part 7 against moving in the actuation direction A, in particular when the cover 10 is in its closed position. Different realizations of the locking device 22 are possible.

Preferably, the locking device 22 acts between the cover 10 and the base 11. In particular, the locking device 22 interlocks the cover 10 and the base 11 so that depressing of the cover 10 is not possible when the cover 10 is closed.

In the present embodiment, the locking device 22 comprises at least one stop 23, here two stops 23, formed at the cover 10, preferably at opposite side and/or adjacent to the pivot axis P. The at least one stop 23 interacts with the base 11, the covering part 15 or a rim 24, in particular with a respective recess formed at the rim 24, such that the cover 10 can not be depressed in its closed position. Only when the cover 10 has been pivoted to its open position, the stops 23 do not interfere with the base 11, covering part 15, and/or rim 24 so that depression of the cover 10 in the actuation direction A is possible. However, other constructional solutions are possible as well.

Preferably, the locking device 22 locks the cover 10 in a form-fit manner to the base 11 in the locked state (i.e. when the cover 10 is closed).

FIGS. 1 and 2 show the sprayhead 2 with closed cover 10. Depression of the cover 10 (in actuation direction A for opening the valve 5 to dispense liquid 3) is blocked or prevented by the locking device 22. When the cover 10 is pivoted into its open position shown in FIGS. 3 to 5, the nozzle 9 in uncovered. In the present embodiment, the cover 10 is retracted between the opening 14/covering part 15 on one side and the nozzle 9 on the other side. Then, the sprayhead can be actuated or dispensing initiated by (manually) depressing the cover 10. This depressed state is shown in FIGS. 6 and 7. The cover 10 has been moved together with the supply member 12/supply part 7 in the actuation direction A and, thus, moved the valve element 6 in the same direction so that the valve 5 is opened.

If the cover 10 is released, the spring force acting on the valve element 6 returns the supply part 7 and, thus, the supply member 12 and cover 10 to its non-depressed state. However, the sprayhead 2 may comprises additionally or alternatively another return means, such as a spring, or the like.

In particular, the sprayhead 2 and/or the locking device 22 may be designed such that the supply member 12 and the cover 10 are returned upwardly into the non-depressed position by pivoting the cover 10 back from its open position to its closed position. This may be achieved e.g. by the interaction of the stops 23 with the rims 24. This is realized in the present embodiment by a respective arrangement and form of the stops 23 (near the pivot axis P) and a suitable form of the cooperating rim 24.

After or during return of the cover 10 to its non-depressed state, the cover 10 can be pivoted back into its closed position in order to lock the sprayhead 2 against actuation.

In the following, further embodiments of the sprayhead 2 according to the present invention will be described. However, the following description focuses only on relevant differences so that the previous description applies preferably in addition or in a similar manner.

FIG. 11 shows a second embodiment of the sprayhead 2 according to the present invention. Here, the locking device 22 (additionally or alternatively to the at least one stop 23) comprises an interlocking means where a preferably longitudinal portion 25 of the base 11 or its covering part 15 cooperates with an opening 26 such that the portion 25 is inserted into the opening 26 when the cover 10 is closed. FIG. 11 shows the cover 10 in the open position, i.e. the portion 25 does not engage into the opening 26 in this state.

Preferably, the portion 25 extends from the rim 24 of the covering part 15 of the base 11 and/or extends partially on the outer surface of the cover 10.

Preferably, the portion 25 has a tip in the form of an arrow in order to facilitate operation and/or to realize a clicking or ratchet effect when the portion 25 is inserted into the opening 26.

The opening 26 is preferably formed in or by the cover 10, in particular by or in the actuation portion 13.

FIGS. 12 to 14 shows a third embodiment of the sprayhead 2 according to the present invention. FIG. 12 shows the sprayhead 2 in a perspective view with open cover 10. FIG. 13 shows the sprayhead 2 in a side view with open cover 10. FIG. 14 shows the sprayhead 2 in a side view with closed cover 10.

Here, the locking device 22 comprises the edge 27 of the cover 10 cooperating with the rim 24 of the base 11. In particular, the base 11 does not comprise the opening 14 or the covering part 15. Instead, the rim 24 extends preferably in a radial plane with respect to the actuation direction A. The edge 27 contacts the rim 24 preferably in the actuation direction A when the cover 10 is closed as shown in FIG. 14.

In general, the sprayhead 2 comprises preferably at least one of the following features:

Preferably, the cover 10 is depressible in the actuation direction A only in the open position in order to actuate the sprayhead 2.

Preferably, the sprayhead 2 is constructed such that part of the cover 10—preferably a rear part of the cover 10 at the side opposite of the nozzle 9—is moveable inside the sprayhead 2—preferably within a base 11 of the spray head 2—in the open position.

Preferably, the stationary covering part 15 partly covers the cover 10 in the closed position.

Preferably, the covering part 15 comprises an opening 14 associated to the nozzle 9 so that the liquid 3 can be dispensed through the opening 14.

Preferably, the opening 14 is closed by the cover 10 in the closed position.

Preferably, the opening 14 is essentially longitudinal or oval so that the nozzle 9 can dispense the liquid 3 through the opening 14 even when the nozzle 9 is moved together with the supply member 12 in the actuation direction A and, thus, relatively to the opening 14.

Preferably, the pivot axis P intersects the actuation direction A and/or a central axis of the sprayhead 2 or of the container 4 as shown in FIG. 7.

Preferably, the hemispherical form of the cover 10 defines a base circle, the pivot axis P intersecting the base circle or the center of the base circle. The base circle in formed in particular by the lower rim of the cover 10 shown in FIG. 8.

Preferably, the pivot axis P is located at a lower end of the cover 10.

Preferably, the sprayhead 2 is formed by five parts at most, preferably by four parts or less. In particular, the sprayhead 2 is made of or consists of only the following parts or components: base 11, supply member 12, cover 10, and optionally nozzle insert 16.

Preferably, the supply part 7 and the cover 10 are depressible in the actuation direction A only rectilinear.

Preferably, the supply part 7 forms a bearing surface for the cover 10. Preferably, the bearing surface is essentially complementary to an inner surface of the cover 10, in particular at least essentially hemispherical.

Preferably, the sprayhead 2 comprises or forms an essentially hemispherical end.

Preferably, the cover 10 does not extend laterally over the sprayhead 2 or base 11 neither in the closed position nor in the open position of the cover 10.

The features of the different embodiments and the embodiments itself can be combined in any suitable manner or used in other constructions or sprayheads or dispensing devices.

### LIST OF REFERENCE SIGNS

1 dispensing Device
2 sprayhead
3 liquid
4 container
5 valve
6 valve element
7 supply part
8 supply channel
9 nozzle
10 cover
11 base
12 supply member
13 actuation portion
14 opening
15 covering part
16 nozzle insert
17 groove
18 protrusion
19 nose
20 bearing bolt
21 bearing arm
22 locking device
23 stop
24 rim
25 portion
26 opening
27 edge
A actuation direction
P pivot axis
S spray direction

What is claimed is:

1. Sprayhead for dispensing a liquid, comprising:
a supply part through which the liquid can be supplied, preferably wherein the supply part can be moved in an actuation direction (A) for opening or initiating supply of liquid,
a nozzle fluidically connected to the supply part, and
a cover associated to the nozzle and pivotable around a pivot axis (P) between (a) a closed position for covering the nozzle and/or blocking actuation of the sprayhead, and (b) an open position for uncovering the nozzle and/or unblocking actuation of the sprayhead,
wherein
the cover is at least essentially hemispherical.

2. Sprayhead according to claim 1, wherein the nozzle and/or cover is/are moveable together with the supply part in the actuation direction (A).

3. Sprayhead according to claim 1, wherein the sprayhead comprises a preferably rigid base for mounting the sprayhead, the base being preferably connectable to a container.

4. Sprayhead according to claim 1, wherein the sprayhead comprises a preferably rigid supply member forming or holding the supply part, a supply channel and/or the nozzle.

5. Sprayhead according to claim 3, wherein the supply member is held or guided by the base, in particular such that the supply member is moveable in the actuation direction (A).

6. Sprayhead according to claim 4, wherein the supply member is preferably only translationally moveable in the actuation direction (A).

7. Sprayhead according to claim 4, wherein the cover is pivotably connected with and/or held by the supply member.

8. Sprayhead according to claim 1, wherein the cover is pivotably held on opposite sides.

9. Sprayhead according to claim 1, wherein the sprayhead or the cover forms or comprises an actuation portion for manually actuating the sprayhead by depressing the cover to move the supply part in the actuation direction (A).

10. Sprayhead according to claim 1, wherein the spray direction (S) of the sprayhead or the nozzle extends at least essentially horizontally and/or transversally to the actuation direction (A) and/or pivot axis (P).

11. Sprayhead according to claim 1, wherein the sprayhead comprises a locking device for locking the cover and/or supply part against moving in the actuation direction (A) in the closed position of the cover.

12. Sprayhead according to claim 3, wherein the locking device acts between, in particular interlocks, the cover and the base.

13. Sprayhead according to claim 11, wherein the locking device comprises a stop formed at the cover or is formed by a rim of the base or by a preferably interlocking portion of the base cooperation with an opening of the cover.

14. Sprayhead according to claim 1, wherein the pivot axis (P) extends at least essentially horizontally and/or transversally to the actuation direction (A).

15. Sprayhead according to claim 1, wherein the cover is depressible in the actuation direction (A) only in the open position in order to actuate the sprayhead.

16. Sprayhead according to claim 1, wherein the sprayhead is constructed such that part of the cover—preferably a rear part of the cover at the side opposite of the nozzle—is moveable inside the sprayhead—preferably within a base of the sprayhead—in the open position.

17. Sprayhead according to claim 1, wherein the sprayhead comprises a stationary covering part which partly covers the cover in the closed position.

18. Sprayhead according to claim 17, wherein the covering part comprises an opening associated to the nozzle so that the liquid can be dispensed through the opening.

19. Sprayhead according to claim 18, wherein the opening is closed by the cover in the closed position.

20. Sprayhead according to claim 18, wherein the opening is essentially longitudinal or oval so that the nozzle can dispense the liquid through the opening even when the nozzle is moved in the actuation direction (A) and, thus, relatively to the opening.

21. Sprayhead according to claim 1, wherein the pivot axis (P) intersects the actuation direction (A) and/or a central axis of the sprayhead or of an container connectable to the sprayhead.

22. Sprayhead according to claim 1, wherein the hemispherical form of the cover defines a base circle, the pivot axis (P) intersecting the base circle or the center of the base circle.

23. Sprayhead according to claim 1, wherein the pivot axis (P) is located at a lower end of the cover.

24. Sprayhead according to claim 1, wherein the sprayhead is formed by five parts at most, preferably by four parts or less, in particular the sprayhead is made of or consists of only the following parts or components: a base, a supply member, the cover, and optionally an nozzle insert.

25. Sprayhead according to claim 1, wherein the supply part and the cover are depressible in the actuation direction (A) only rectilinear.

26. Sprayhead according to claim 1, wherein the supply part forms a bearing surface for the cover.

27. Sprayhead according to claim 26, wherein the bearing surface is essentially complementary to an inner surface of the cover, in particular at least essentially hemispherical.

28. Sprayhead according to claim 1, wherein the sprayhead comprises an essentially hemispherical end.

29. Sprayhead according to claim 1, wherein the cover does not extend laterally over the sprayhead or a base of the sprayhead neither in the closed position nor in the open position of the cover.

30. Dispensing device for dispensing a liquid, comprising:
a container with the preferably pressurized liquid,
an outlet device connected to the container, and
a sprayhead having a supply part connected to the outlet device,
wherein
the sprayhead is constructed according to claim 1.

31. Dispensing device according to claim 30, wherein the outlet device is a valve comprising a moveable valve element which is biased by spring into a non-operating position, wherein the supply part is associated to the valve element so that the valve element moved against the spring force in a position where the valve is open when the sprayhead is actuated, in particular the supply part or cover moved in the actuation direction (A).
